(19) United States
(12) Patent Application Publication
(10) Pub. No.: US 2008/0142477 A1
(43) Pub. Date: Jun. 19, 2008

(54) Process for the Selective Etching of a Glass Article Surface

(75) Inventor: Nadia Jacobs, Jumet (BE)

Correspondence Address: AKERMAN SENTERFITT, P.O. BOX 3188, WEST PALM BEACH, FL, 33402-3188, US

(73) Assignee: GLAVERRBEL-Centre R & D, Jumet (BE)

(21) Appl. No.: 11/816,111

(22) PCT Filed: Feb. 14, 2006
(86) PCT No.: PCT/EP06/50914

§ 371 Date: Aug. 13, 2007

(30) Foreign Application Priority Data
Feb. 18, 2005 (EP) 05101222.7

(51) Int. Cl. C03C 15/00

(52) U.S. Cl. 216/49

(57) ABSTRACT

Process for the selective etching of a glass article surface with a hydrofluoric acidic solution, comprising a first step of selective protection of the surface with a wax deposited by an ink-jet head, a second attack step by the acidic solution and a third cleaning step of the surface.

This invention relates to selective etching of glass. In particular, it relates to selective etching of glass article surfaces by means of hydrofluoric acid aqueous solutions.

Various glass etching processes are known for a long time, all having in common the preservation of selective surfaces of the glass by a protective coating that is removed after the action of the acid. Some use dipping of the glass into a molten wax followed by selective removal of the solidified wax at places to be etched, others, like serigraphy, apply wax selectively on glass article surfaces to be protected.

Neither of those known processes however allows the economical and industrial etching of large glass article surfaces. In particular,
dipping thin uniform wax layers on large glass article surfaces are too difficult to control. Removing protective wax from large surfaces further to be etched reveals itself tedious and anti-economical;
serigraphy of wax requires uniform heat distribution on large frames to melt the wax and can only be done reproductively on small surfaces.

Additionally, selective application of the acid solution, for example by direct serigraphy is as well difficult to achieve, especially to obtain the desired etching degree.

The invention provides the advantage of a process for selective etching large glass article surfaces, which can be performed industrially at relatively low costs.

The invention concerns a process for the selective etching of at least one glass article surface with aqueous solutions of hydrofluoric acid comprising the following steps, in sequence:
a) a protective step during which at least one area of the surface that should not be etched is protected by deposition of a protective coating, so as to obtain a selectively coated glass article surface,
b) an attack step during which the uncoated areas of the surface are etched by contacting the selectively coated glass article surface with the acid solution,
c) a finishing step consisting of cleaning the glass article surface by wiping the protective coating, followed by a rinsing the surface,
   according to which the protective coating is a coating layer of low-temperature melting wax that is deposited on selective areas of the glass article surface during the protective step by means of at least one dispensing device that comprises at least one ink-jet head, which fuses the wax.

By glass article surface, it is intended to designate planar as well as non-planar external surfaces of glass articles. The process according to the invention is preferably used for planar surfaces, especially for glass sheets. That process is particularly convenient for glass sheets produced by the float glass manufacturing process.

The process according to the invention is used for etching glass article surfaces. By etching glass article surface, it is meant either 1) frosting and generally opalising or making opaque at least part of the surface of a glass object, 2) removing some quantity of glass material at the top of that surface, or 3) giving a specific texture to the glass surface. Said glass surfaces may consist of clear glass, or consist of a previously etched glass, indifferently. According to the process of the invention, the etching is selectively done at localised parts of the glass article surface, leaving the remaining parts unchanged.

The etching compliant to the process according to the invention is done by means of an acidic chemical attack of the glass article surface with an aqueous solution of hydrofluoric acid. Generally, attack aqueous solutions of hydrofluoric acid have a pH of from 0 to 5. Such aqueous solutions may comprise, in addition to hydrofluoric acid itself, salts of that acid, other acids like HCl, H₂SO₄, HNO₃, phosphoric acids and their salts (e.g. Na₂SO4, K₂SO4, (NH₄)₂SO₄, BaSO₄, . . . ) and optional adjuvants in minor proportions (e.g. acid/base buffer compounds, or compounds facilitating spreading of the solution, . . . ). Alkaline salts and ammonium salts are generally preferred, like sodium, potassium and ammonium hydrofluoride and/or bifluoride. Example of a suitable solution is an aqueous solution of HF comprising from 0 to 600 g HF per litre of solution, preferably from 150 to 250 g/l, together with from 0 to 700 g/l of NH₄HF₂, preferably from 150 to 300 g/l.

According to the invention, the process comprises three successive steps, performed in sequence: a protective step, an attack step and a finishing step.

During the first step, or the protective step, at least one area of the glass article surface that should not be etched is protected by deposition of a protective coating, so as to obtain a selectively coated glass article surface. According to the invention, the protective coating is a coating layer of solid low-temperature melting wax that is deposited, in a molten state, on selective areas of the glass article surface during the protective step, by means of at least one dispensing device, which fuses the wax. The molten wax dispensed on the glass article surface solidifies then rapidly to form a solid coated layer.

Waxes that can be used may be of natural or synthetic origin. When of natural origin, waxes may belong to animal, vegetable or mineral categories. Mineral waxes extracted from oil are preferred. More preferably, they are paraffins and microcrystalline waxes. Paraffin wax generally consists mostly of straight chain hydrocarbons with 80 to 90% normal paraffin content and a balance of branched paraffins (isoparaffins) and cycloparaffins. When of synthetic origin, they may belong to reformatted hydrocarbons, halogenated naphtalenes and ethylenic polymers. Preferably, they consist of ethylenic polymers. Polymers of ethylene and polyol ether-esters are particularly well suited. As an example of a well suited synthetic wax, low-density polyethylene can be mentioned. Polyethylene polymer may have a molecular mass from 300 to 10000. Preferably, polyethylene has a molecular mass of from 500 to 5000 and, more preferably, of from 600 to 900. Mixtures of at least one natural and/or synthetic particular wax in whatever proportions may as well be used.

Preferably, the wax compliant to the process according to the invention has a melting point of from 50 to 140° C. More preferably, they have a fusing point of from 60 to 95° C.

If in molten state at 100° C., the wax used has preferably a dynamic viscosity at that temperature of from 5 to 30 mPa·s and, more preferably of from 10 to 20 mPa·s.

During the second step, or attack step, the operation of contacting the uncoated areas of the surface with the aqueous fluorhydric acid solution may be done by any technique capable to guarantee a close contact of the liquid aqueous acid solution and the uncoated areas of the glass article surface to be attacked. For example, it can be done by immersing the entire glass article in an acidic attacking bath. It can alternatively be performed as well by leaching the selectively protected glass article surface with the acidic attacking solution. Another possible process for that second step is the spraying of acidic solution droplets on the surface to be attacked. That step may be performed at ambient temperature or with an article and/or attack solution slightly heated. The temperature of the article and/or the solution may however remain moderate for never melting the wax coating layer. Duration of the step has to be carefully adapted and monitored in relation to the degree of etching sought and the other conditions of temperature and pression. Generally, that duration is at least of 10 seconds. That duration is also no longer than 20 minutes. Preferably, the attack step is no shorter than 20 seconds. Preferably as well, the attack step is no longer than 12 minutes.

It is recognised that processes including several successive attack steps of a selectively coated glass article surface belong as well to the invention. According to that embodiment, the steps may consist of simple repetitions of one particular attack step. Another embodiment of the process according to the invention includes a sequence of attack steps that may differ in their acid solution characteristics and/or operating conditions.

The third step of the process according to the invention consists of two successive phases: a wiping from the glass article surface of the protective coated layer of wax, followed by a rinsing of that surface. Optionally, a third neutralising pre-phase may be performed by contacting a liquid or vapour neutraliser, which aims at more rapidly stopping the attack of the uncoated glass by the acid. As neutraliser, any alkaline solution or vapour may be used, or even, alternatively, neutral aqueous or non-aqueous solution or vapour. Generally, the wiping phase of the third step is done with the projection of a hot solution that fuses the wax and flushes away the protective coating layer. The hot solution may indifferently be aqueous or organic. Aqueous hot solutions are preferred. Optionally, the hot solution may comprise at least one detergent and/or one organic solvent that helps in emulsifying and flushing away the wax coating layer. A wiping phase performed by leeching of hot water has given good results.

The process according to the invention is particularly well suited to the etching of large glass surface articles. Preferably, the glass surface is at least of 5 m². It is understood that the process according to the invention may as well be used easily for etching smaller surfaces, for example surfaces of the order of magnitude of 0.25 m².

According to the invention, the protective step of the process comprises, as a dispensing device that fuses the wax, at least one ink-jet head. The latter is generally integral with a moving carriage that can position the head at any point along at least one direction contained in one surface of the glass article. In some particular dispensing devices, the moving carriage may as well position the head along more than one direction contained in the surface, allowing in this case the covering of the entire surface by itself alone, without requiring any movement of the glass article.

According to the invention, the ink-jet head may comprise a row of small nozzles capable of ejecting molten wax. Each nozzle may be actuated separately. When actuated all together, the nozzles are dispensing a ribbon of molten wax on the surface of the glass article.

For a given point of the surface to be protected, the protective step comprises at least one excursion of the ink-jet head. In other words, at a particular place of the surface of the object article to be protected, during the protective step, the ink-jet head is moving over and dispensing molten wax at least one time.

Advantageously, at a given point of the glass article surface to be protected, there may be two or three successive excursions of the head for depositing molten wax, so as to thicken the coated protective layer.

Preferably, the moving ink-jet head is positioned slightly differently at each excursion, so as to fill possible gaps between previously deposited wax ribbons.

The entire 3-step process compliant to the invention may be performed only one time. It may as well be repeated a number of times up to the reaching of the aimed glass surface. In this embodiment, repetition process cycles may consist of exactly the same process (chemicals, operating conditions). Chemicals and/or conditions may also be adapted from repetition to repetition in order to modulate the speed of the attack. Another possible embodiment consists of repeating the particular second attack step in one or several of the process cycles.

The invention concerns as well a glass etched by the above process.

The invention will now be illustrated with some examples, without aiming at limiting in any way its coverage.

### EXAMPLE 1

### Compliant to the Invention

A sheet of clear glass, 4 mm in thickness and of a surface of 7.7 m² (2.4 m×3.21 m) has been cleaned with an aqueous detergent and carefully rinsed with water and then dried.

A protective coating made of ribbons of branched hydrocarbon micro-crystalline paraffin from Paramelt (HG grade, melting point 80-86° C.) has been dispensed selectively on areas figuring an image of squares by three successive excursions of an ink-jet head comprising 256 nozzles aligned along a straight line. The print head was heated at 110° C., and was ejecting at 18000 Hz. The thickness of the protective coating obtained has been from 20 to 70 μm, each ribbon dispensed having a width of 80 to 150 μm and the contiguous ribbons overlapping slightly in order to eliminate any gap.

An acidic attack solution composed of 20 weight % HF and 62 weight % NH₄HF₂ in water at 20-25° C. has further been drawn onto the whole glass article surface and the attack has been allowed to take place for 5 minutes.

The attack solution has further been rinsed with water and the paraffin coating has then been flushed with hot water jets. Then, a final cleaning with an aqueous detergent has been performed.

### EXAMPLE 2

### Compliant to the Invention

A sheet of clear glass, 4 mm in thickness and of a surface of 0.32 m² (0.4 m×0.8 m) has been cleaned with an aqueous detergent and carefully rinsed with water and then dried.

A protective coating made of ribbons of branched hydrocarbon micro-crystalline wax from Paramelt (HG grade, melting point: 80-86° C.) blended with 12% A-C® homopolymer polyethylene wax has been dispensed selectively on areas figuring an image of lines by three successive excursions of an ink-jet head comprising 256 nozzles aligned along a straight line. The print head was heated at 115° C., and was ejecting at 18000 Hz. Thickness of the protective coating obtained has been from 20 to 70 μm, each ribbon dispensed having a width of 80 to 150 μm, with a slight overlapping in order to avoid any gap.

An acidic attack solution composed of 10 weight % HF and 10 weight % HCl in water at 20-25° C. has further been drawn onto the whole glass article surface and the attack has been allowed to take place for 30 seconds.

The attack solution has further been rinsed with water and the paraffin coating has then been flushed with hot water jets. Then, a final cleaning with an aqueous detergent solution has been performed.

### EXAMPLE 3

### Comparative Example Non-Compliant to the Invention

A sheet of matted glass, 4 mm in thickness and of a surface of 0.32 m² (0.4 m×0.8 m) has been cleaned with an aqueous detergent and carefully rinsed with water and then dried.

A protective coating made of ribbons of Callista® 158 synthetic paraffin wax (melting point: 72-77° C.) has been dispensed selectively on areas figuring an image of lines using an applicator device manufactured by the Preo SRL Italian company, equipped with a Trafto® 2 microprocessor. An acidic attack solution composed of 10 weight % HF and 10 weight % HCl in water at 20-25° C. has further been drawn onto the whole glass article surface and the attack has been allowed to take place for 15 minutes.

The attack solution has further been rinsed with water and the paraffin coating has then been flushed with hot water jets. Then, a final cleaning with an aqueous detergent solution has been performed.

### EXAMPLE 4

### Comparative Example Non-Compliant to the Invention

A sheet of clear glass, 2 mm in thickness and of a surface of 0.12 m² (0.4 m×0.3 m) has been cleaned with an aqueous detergent and carefully rinsed with water and then dried.

A protective coating of hot melt wax blend from Markem (grade 5003 Series) has been dispensed selectively on areas figuring an image of lines printed with a Markem 5200 case printer coder positioned at a “density” of 4. Thickness of the protective coating obtained has been from 20 to 70 μm, each ribbon dispensed having a width of 60 to 120 μm and being spaced by 20 to 80 μm from the previous one.

An acidic attack solution composed in volume of 50% NH₄HF₂, 25% water, 6% concentrated H₂SO₄, 6% HF (of an aqueous solution of 50 weight %), 10% K₂SO₄, 3% (NH₄)₂SO₄ at 20-25° C. has further been drawn onto the whole glass article surface and the attack has been allowed to take place for 5 minutes.

In this example the protection has been used to delay the attack at the protected places, in order to realise a network of grooves of alternate rugosities.

1. Process for the selective etching of at least one glass article surface with aqueous solutions of hydrofluoric acid comprising the following steps, in sequence:
a) a protective step during which at least one area of the surface that should not be etched is protected by deposition of a protective coating, so as to obtain a selectively coated glass article surface,
b) an attack step during which the uncoated areas of the surface are etched by contacting the selectively coated glass article surface with the acid solution,
c) a cleaning step consisting of cleaning the glass article surface by wiping the protective coating followed by a rinsing of the surface,
characterised in that the protective coating is a coating layer of low-temperature melting wax that is deposited on selective areas of the glass article surface during the protective step by means of at least one dispensing device that comprises at least one ink-jet head, which fuses the wax.

2. Process according to claim 1, characterised in that the glass article surface is of at least 5 m².

3. Process according to claim 1, characterised in that the protective step comprises for a given point of the surface to be protected at least one excursion of the ink-jet head dispensing a ribbon of molten wax.

4. Process according to claim 1, characterised in that the protective step comprises three successive excursions of the dispensing ink-jet head for a given point of the surface to be protected.

5. Process according to claim 4, characterised in that the ink-jet head is positioned slightly differently at each excursion so as to fill possible gaps between previously deposited wax ribbons.

6. Process according claim 1, characterised in that the wax melting point is from 50 to 140 degrees Celsius.

7. Process according to claim 1, characterised in that the wax melting point is from 60 to 95 degrees Celsius.

8. Process according to claim 1, characterised in that the wax is selected from any mixture in whatever proportions of at least one natural and/or synthetic particular wax.

9. Process according to claim 8, characterised in that the molten wax has a dynamic viscosity at 100° C. of from 5 to 30 mPa·s and, preferably of from 10 to 20 mPa·s.

10. Process according to claim 8, characterised in that natural wax is selected from mineral waxes extracted from oil, like paraffin and microcrystalline waxes.

11. Process according to claim 8, characterised in that synthetic wax is selected from ethylenic polymers like polyethylene and polyol ether-esters.

12. Process according to claim 1, characterised in that the attack step has duration, which is no shorter than 5 minutes.

13. Process according to claim 1, characterised in that during the cleaning step, the wiping is performed by leeching the glass article surface with hot water.

14. Process according to claim 13, characterised in that a detergent is present in the wiping water.

15. Glass etched by a process according to claim 1.
